(19) United States
(12) Patent Application Publication
(10) Pub. No.: US 2016/0343018 A1
(43) Pub. Date: Nov. 24, 2016

(54) DISCOUNT SERVICE SYSTEM AND METHOD ACCORDING TO DISCOUNT CONDITIONS

(71) Applicant: IVYBERRY CO., LTD, Guro-gu Seoul (KR)

(72) Inventor: Yong Duk BALK, Seoul (KR)

(21) Appl. No.: 15/112,542

(22) PCT Filed: Dec. 11, 2014
(86) PCT No.: PCT/KR2014/012189

§ 371 Date: Aug. 9, 2016

(30) Foreign Application Priority Data
Jan. 21, 2014 (KR) 10-2014-0007227

(51) Int. Cl. G06Q 30/02

(52) U.S. Cl. CPC G06Q 30/0222; G06Q 30/0225; G06Q 30/0235

(57) ABSTRACT

The present invention relates to a discount service system and method according to a discount condition which defers the payment in accordance with the coupon purchase of a buyer, and changes the payment to a discount condition related with the coupon usage at the time of performing the payment to process the payment amount. According to the present invention, a payment procedure of the coupon purchased by the buyer is deferred later than the coupon used time or coupon usage and various discount conditions is set to apply additional benefit in accordance with the coupon usage of the seller to provide a discount in accordance with a discount condition in connection with the coupon usage of the buyer, to guide the buyer to use a coupon in a seller's desired direction, thereby maximizing the benefit of the seller.

### CROSS-REFERENCE TO RELATED APPLICATION

This application claims the benefit of Korean Application No. 10-2014-0007227 filed on Jan. 21, 2014 with the Korean Intellectual Property Office, the disclosure of which is incorporated herein by reference.

### BACKGROUND OF THE INVENTION

1. Field of the Invention

The present invention relates to a discount service system and method according to discount conditions, and more particularly, to a discount service system and method according to discount conditions which defers payment in accordance with purchase with a coupon and processes the payment by changing a payment amount in accordance with a discount condition related with the coupon at the time of processing the payment.

2. Description of the Related Art

Currently, a user terminal which includes various applications interlocking with a network is provided and the user may be provided with various commercial transaction related services through the application included in the user terminal.

As a commercial transaction related service which is provided in recent years, in addition to a service which simply sells a product on the online, a social commerce related service which collects a predetermined number of buyers to sell the products or services related with a franchise store at a discounted price is being provided.

A social commerce related service provider issues a coupon for providing a product or a service of a franchise store at a discounted price to a purchaser's terminal and the purchaser presents the coupon stored in the purchaser's terminal at the franchiser store to receive the coupon related product or service.

In this case, the social commerce related service provider distributes the coupons for free or issues paid coupons in accordance with a sales policy of a seller. In the case of the paid coupons, the coupons may be used after being paid in advance.

Therefore, the seller needs to designate a time to sell the coupons and a number of coupons to be issued, and register the sales policy to a server of a social commerce related service provider. Since the sales policy which is registered, it is difficult to modify the sales policy so that the registered sales policy needs to be maintained until the time to sell the coupons ends. Therefore, a social commerce related service of the related art provides just a discount service through a coupon so that lots of problems are deducted.

First, when a franchise store distributes the coupons for free to promote the sales, it causes complains of a buyer who bought the product at a normal price. Therefore, reliability of the franchise store is lowered and interest of the franchise store is also lowered so that awareness of the franchise store is also lowered.

In the meantime, when the coupon is provided by being paid, the coupon needs to be paid in advance and then is used. Therefore, the franchise store needs to fix a discounted price of the coupons when the discounted price of the coupon is determined. The franchise store predicts the estimated number of buyers in consideration of a break-even point and determines a discounted price in accordance with the number of buyers. When the number of actual buyers does not reach the estimated number of buyers, a burden of the seller is increased due to the loss.

Further, since the payment is completed at the time of purchasing the coupons, it is difficult to provide the discount only at a time zone when the purchasing power is lowered. Therefore, the coupons may be mostly used at a peak time and thus, it is very difficult to maximize a profit at a peak time when the number of purchasing is sufficient.

Furthermore, the commercial transaction service using a coupon such as a social commerce is configured such that a franchising store builds a separate server to collect coupon information on a used coupon and then transmits the coupon information to a commercial transaction related server to calculate the amount corresponding to the used coupons. Therefore, a local store which is operated in a small size has a difficulty to build an independent server for collecting the coupon information. Further, when the buyer does not use the purchased coupon, a refund amount is sharply increased in accordance with the number of buyers. Therefore, the loss of the local store is significant. The commercial transaction service is mainly operated in partnership with a large size franchise store so that it is difficult for the local store to participate the commercial transaction service.

### RELATED ART DOCUMENT

### Patent Document

(Patent Document 1) Korean Unexamined Patent Application Publication No. 10-2007-0029549

### SUMMARY OF THE INVENTION

The present invention has been made in an effort to support a coupon seller to freely designate one or more discount conditions related with the coupons, also freely designate a cost corresponding to each discount condition when there is a plurality of discount conditions to provide diversity of the coupon operation, secure autonomy of an owner of the franchise store to operate the coupon by changing the discounted price at real time and prevent the coupon buyers from being focused at a peak time to maximize the profit.

Further, the present invention has been made in an effort to provide a system, which does not need to build a separate server for managing the issued coupons and calculating the used coupons, minimizes a loss caused by unused coupons of the user and supports the small-sized local market, thereby providing a discount service using the coupons.

According to an aspect of the present invention, A discount service system according to a discount condition may include a discount condition storing unit which receives one or more discount conditions corresponding to a coupon as discount condition information and stores the discount conditions; a coupon issuing unit which transmits coupon information on the coupon in accordance with a coupon purchasing request to a buyer terminal to issue a coupon; a payment information managing unit which generates payment information of the buyer in accordance with the coupon purchasing request to store the payment information to be deferred; a coupon authenticating unit which receives coupon usage information including the coupon information in accordance with the usage of the coupon and seller identification information from the buyer terminal and compares the seller identification information set in advance for the coupon and the coupon usage information to authenticate the usage of the coupon; and a discount processing unit which when the coupon usage is authenticated by the coupon authenticating unit, maintains an amount of the payment information as it is or changes the amount in accordance with a discount condition included in the discount condition information to perform a payment procedure.

The system may further include a location information collecting unit which collects location information of a buyer from the buyer terminal. The coupon providing unit may transmit coupon list information on one or more different coupons including seller position information located within a predetermined radius with respect to the buyer location information based on the buyer location information and seller location information set in advance in the coupon to the buyer terminal.

In an embodiment of the present invention, the coupon providing unit further includes discount condition information corresponding to each coupon included in the coupon list information to transmit the coupon list information to the buyer terminal.

In an embodiment of the present invention, the discount information providing unit may transmit the coupon list information to the buyer terminal as a push message.

In an embodiment of the present invention, the coupon providing unit may compare a discount time zone in accordance with each discount condition corresponding to the coupon for every coupon included in the coupon list information and time information corresponding to the location information of the buyer to select a coupon having a discount time zone including the time information as a discount condition to transmit the coupon to the buyer terminal.

In an embodiment of the present invention, the discount condition information may include one or more discount conditions in which different discount prices are set at every time zone, and the discount processing unit may compare the coupon used time in accordance with the coupon usage information and the time zone for every discount condition to change the amount of the payment information in accordance with the predetermined discounted price in the discount condition corresponding to the time zone including the coupon used time.

In an embodiment of the present invention, when the coupon used time is not included in the time zone of all discount conditions, the discount processing unit may perform payment with the deferred payment information.

In an embodiment of the present invention, the discount processing unit may perform the payment on the payment information which is deferred in a predetermined time and change the amount of the payment information in accordance with the satisfied discount condition to perform the payment when any one of discount conditions included in the discount condition information is satisfied between the payment proceeding time in accordance with the proceeding of the payment and the coupon used time in accordance with the coupon usage information.

In an embodiment of the present invention, the payment information may be statement information in accordance with the card usage of the buyer.

In an embodiment of the present invention, the discount processing unit may transmit approval result information of approval result to the seller terminal when the payment information in accordance with the payment proceeding is approved.

According to still another aspect of the present invention, a discount service method according to discount conditions includes matching coupon information, discount conditions, and seller identification information to store, by a discount service server which communicates with a buyer terminal; issuing a coupon in accordance with a coupon purchasing request signal of the buyer terminal, by the discount service server and storing the payment information in accordance with the coupon purchase to be deferred; receiving coupon usage information including the coupon information and the seller identification information through the buyer terminal, by the discount service server and comparing the previously stored coupon issuing information and seller identification information to provide the result information to a predetermined channel of the seller; and maintaining the amount included in the deferred payment information as it is or changing the amount in accordance with the discount condition to perform the payment when the discount service server authenticates the coupon usage in a face to face status.

According to the present invention, a payment procedure of the coupon purchased by the buyer is deferred later than the coupon used time or coupon usage, various discount conditions is set to apply additional benefit in accordance with the coupon usage of the seller to provide a discount in accordance with a discount condition in connection with the coupon usage of the buyer, to guide the buyer to use a coupon in a seller's desired direction, thereby maximizing the profit of the seller. Further, additional discount in addition to the coupon usage other than the discount in accordance with the coupon purchase is also provided, thereby improving satisfaction of the buyer.

According to the present invention, the discount condition is scheduled in accordance with a seller's desired time or strategy to be applied to the coupon, so that the seller freely sets an operating policy of the coupon to maximize the operating efficiency of the coupon so as to secure extendibility and autonomy for building a coupon operating policy.

Further, according to the present invention, the seller designates a sales time, a product or service which is bad is designated to be set as a discount condition. Therefore, clients which are flocked at a peak time are distributed and a high discount condition is applied at a time zone when the clients rarely visit to actively lead the client to visit the store or promote sales of product or services which are weal for sale, thereby maximizing a sales profit.

Further, according to the present invention, all processes related with the coupon issuing are supported and the payment procedure in accordance with the coupon issuing is performed after using the coupon, so that a loss of the small size local store due to the unused coupon may be minimized, thereby easily supporting the local store to easily utilize the discount service using the coupon.

### BRIEF DESCRIPTION OF TEE DRAWINGS

FIG. 1 is a view of configuration environment of a discount service system according to discount conditions according to an exemplary embodiment of the present invention.

FIG. 2 is a view of a configuration of a discount service server according to an exemplary embodiment of the present invention.

FIG. 3 is a view of a configuration of issuing a coupon and deferring payment of a discount service server according to an exemplary embodiment of the present invention.

FIG. 4 is a view of a configuration of storing and providing discount condition information of a discount service server according to an exemplary embodiment of the present invention.

FIG. 5 is an exemplary view of a buyer position based coupon recommending process of a discount service server according to an exemplary embodiment of the present invention.

FIG. 6 is an exemplary view of providing a coupon list and detailed contents of a coupon in a buyer terminal according to an exemplary embodiment of the present invention.

FIG. 7 is a view of a configuration of a coupon authenticating process of a discount service server according to an exemplary embodiment of the present invention.

FIG. 8 is a view of a configuration of applying a discount condition in accordance with usage of a coupon of a discount service server according to an exemplary embodiment of the present invention.

FIG. 9 is an exemplary view of applying a discount condition in accordance with usage of a coupon of a discount service server according to an exemplary embodiment of the present invention.

FIG. 10 is a view of a configuration of a collective payment process of a discount service server according to an exemplary embodiment of the present invention.

FIG. 11 is a view of a configuration of applying a discount condition using a game of a discount service server according to an exemplary embodiment of the present invention.

FIG. 12 is a flow chart of a discount service method according to an exemplary embodiment of the present invention.

### DETAILED DESCRIPTION OF TEE PREFERRED EMBODIMENTS

Hereinafter, embodiments of the present invention will be described in detail with reference of the accompanying drawings.

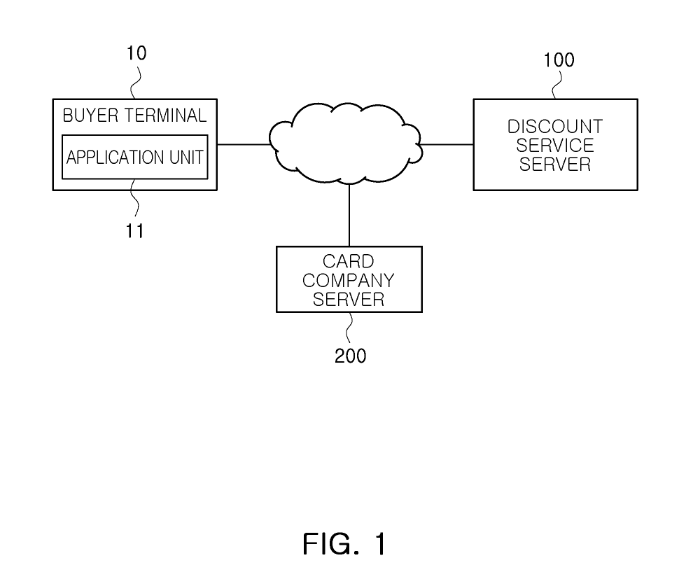

FIG. 1 is a view of a configuration environment of a discount service system according to discount conditions according to an exemplary embodiment of the present invention. As illustrated in the drawing, the discount service system may include a discount service server 100 which provides a coupon for goods or a service provided by a seller and a buyer terminal 10 which accesses the discount service server 100 through a communication network to buy the coupon.

In this case, the buyer terminal 10 may include an application unit 11 which accesses the discount service server 100 to provide coupon related information and allows to buy the coupons.

The seller may refer to as a franchise store which uses a discount service through the discount service server 100 and for example, may include a store where the buyer visits to face, such as a local store or a franchise store.

Further, the discount service server 100 issues coupons to the buyer terminal 10 in accordance with a coupon purchase request of the buyer terminal 10, generates payment information in accordance with the coupon purchase, and transmits the payment information to a card company server 200 which is connected through a communication network to request an approve of the payment information. The card company server 200 approves the payment information and transmits the approval result information to the discount service server 100.

Therefore, the discount service server 100 transmits the approval result information to the buyer terminal 10 to notify the payment processing result in accordance the coupon purchase to the buyer.

In the above configuration, in the related art, the payment information is simultaneously processed at the time of buying the coupon, so that the price of the goods or service corresponding to the coupon is fixed. Therefore, it is difficult to apply various discount conditions.

However, the discount service server 100 according to an exemplary embodiment of the present invention stores payment information generated but deferred when the user terminal 10 buys the coupons in a DB and performs the deferred payment procedure of the payment information on or after the coupon used time of the buyer. In this case, the coupon used time may be a coupon redeem time in accordance with the coupon redeem.

By doing this, the discount service server 100 applies various discount conditions related with the coupon usage and when the discounted condition is satisfied at the time of using the coupon, a cost of the payment information is changed in accordance with the discount condition at the time of proceeding a payment process in accordance with the payment information.

This means that various discount events using coupons may be applied. For example, a discount price varies in accordance with a coupon used time zone. When the coupon is used at a peak time zone, the payment is performed by the coupon price as it is without applying a discount condition or a discount condition with a low discount rate is applied to perform the payment. A discount condition with a high discount rate is applied at a time zone when the clients rarely visit so that the payment amount is changed to perform payment.

As described above, the seller who provides goods or service corresponding to the coupons provides a coupon at a discounted price by the same manner as the social commerce and applies various discount conditions for additional discount other than the discount in accordance with the coupon. Therefore, the discount condition is freely set to distribute the clients who are crowded at the peak time and a high discount condition is applied at a time zone when the client rarely visits to actively induce the client, thereby maximizing a sales profit.

Hereinafter, a detailed configuration of the discount service system which provides a discount service in accordance with the discount condition will be described with reference to the drawings based on the above-described configuration.

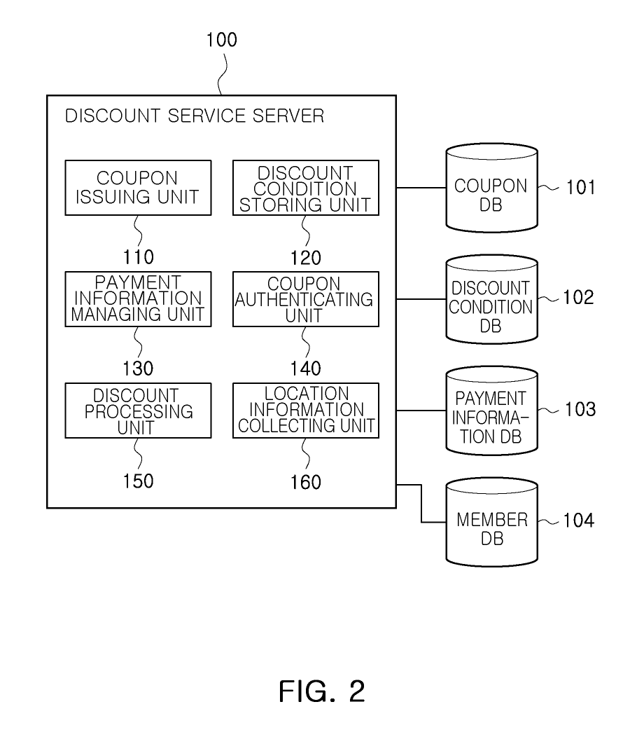

First, as illustrated in FIG. 2, the discount service server 100 may include a coupon issuing unit 110, a discount condition storing unit 120, a payment information managing unit 130, a coupon authenticating unit 140, a discount processing unit 150, and a location information collecting unit 160.

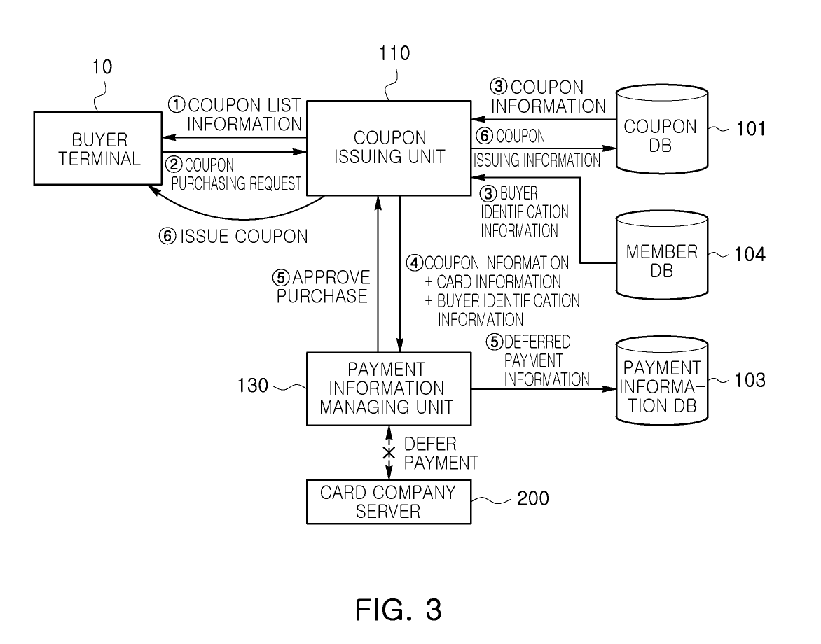

Each configuration will be described below with reference to the drawings. As illustrated in FIG. 3, the coupon issuing unit 110 transmits coupon list information on one or more coupons from a coupon DB 101 to a buyer terminal 10 and receives coupon buying request information on any one of coupons included in the coupon list information from the buyer terminal 10.

In this case, the coupon issuing unit 110 transmits the coupon list information to the buyer terminal 10 as a push message.

Therefore, the coupon issuing unit 110 extracts coupon information corresponding to coupon buying request information from the coupon DB 101. The coupon issuing unit 110 transmits buyer identification information corresponding to the buyer terminal 10 which transmits the coupon buying request information from a member DB 104 and coupon buying request information or card information on a card (for example, a check card or a credit card) which is included in the member information of the member DB 104 and is used to make a payment to the payment information managing unit 130 together with the coupon information.

In this case, the coupon information may include coupon identification information (for example, a coupon code or a coupon ID), seller information (including store information), product or service information, and information in a coupon price and discount rate.

Next, the payment information managing unit 130 generates payment information including the coupon information, buyer identification information, and the card information and the payment information is deferred to be stored in the payment information DB 103 without transmitting the payment information to the card company server 200.

However, the payment information managing unit 130 transmits the card information to the card company server 200 and determines whether the card used to make a payment by the buyer is valid. When the card is not valid, the payment information managing unit 130 transmits purchase failed information to the coupon issuing unit 110 without generating the payment information. The coupon issuing unit 110 transmits the payment failure information to the buyer terminal 10 to stop issuing the coupons.

Therefore, the payment information managing unit 130 generates payment information when the card in accordance with the card information is valid to transmit purchase approval information to the coupon issuing unit 110. The coupon issuing unit 110 transmits coupon information on a coupon corresponding to a purchase request signal through a communication network to the buyer terminal 10 to issue the coupons.

The coupon issuing unit 110 stores coupon issuing information including coupon information on the issued coupon, buyer identification information, seller identification information for authenticating a coupon, and coupon usage information on whether to use a coupon to the coupon DB 101.

In this case, the coupon issuing unit 110 extracts seller information from coupon information corresponding to the issued coupon when the coupon is issued, selects member information of the seller among the member information stored in the member DB 104 based on the extracted seller information, and extracts seller identification information included in the membership information of the seller to be included in the coupon issuing information.

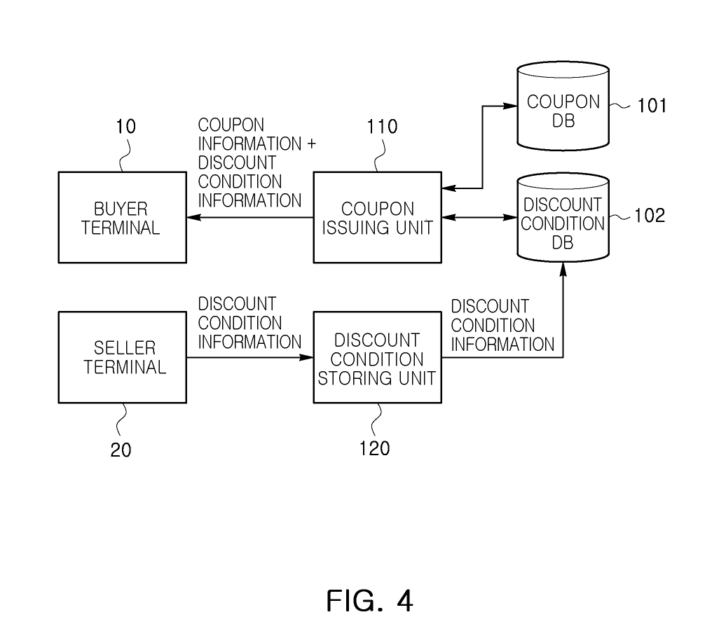

In the meantime, the discount condition storing unit 120 receives discount condition information for one or more discount conditions corresponding to the coupon from the seller terminal 20 and stores the discount condition information in the discount condition DB 102, as illustrated in FIG. 4. In this case, the discount condition storing unit 120 may receive discount condition information from various seller equipment which is connected to the discount service server 100 through a predetermined communication channel and stores the discount condition information.

Further, as the discount condition information, one or more different discount conditions including the coupon identification information, a discount time zone, a discount product or service and a discount price may be set. For example, different discount prices may be set for every discount condition for every discount time zone and a discount price may be set for different discount products or services.

That is, the seller of the seller terminal 20 may generate various discount conditions to transmit the various discount conditions to the discount service server 100. As it will be described below, the discount service server 100 may apply the discount condition to associate with the usage of the coupon.

In the meantime, when the coupon list information is provided, the coupon issuing unit 110 includes the discount condition information corresponding to each coupon in the coupon list information to transmit the discount condition information to the buyer terminal 10. Further, the coupon issuing unit 110 may transmit the discount condition information corresponding to the coupon information to the buyer terminal 10 together with the coupon information provided to the buyer terminal 10 when the coupon is issued.

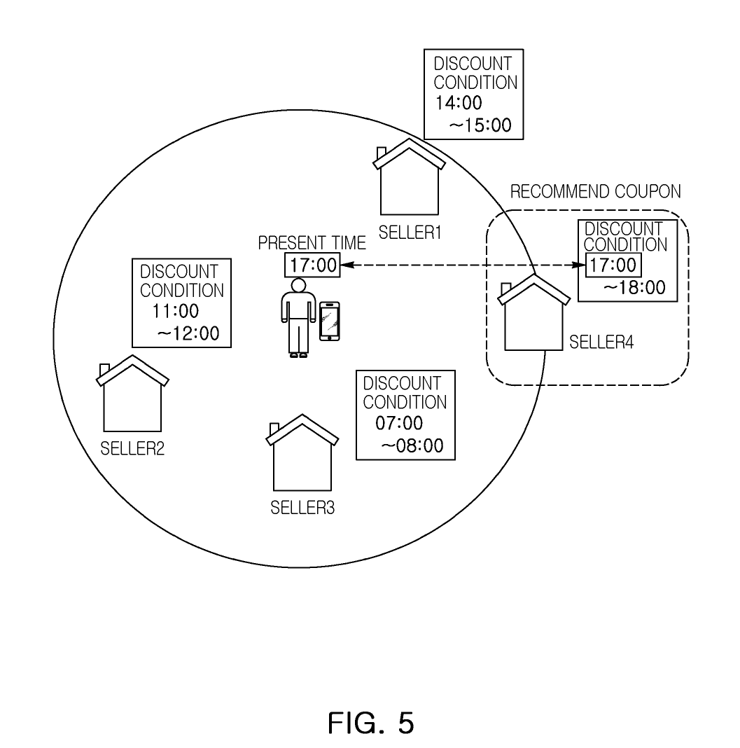

Further, the coupon issuing unit 110 selects the coupon included in the coupon list information based on the location of the buyer to transmit the coupon, which will be described below with reference to FIG. 5.

As illustrated in FIG. 5, the coupon issuing unit 110 may collect location information of the buyer through the location information collecting unit 160. The coupon issuing unit 110 may select one or more buyers within a predetermined radius based on the location of the buyer, based on the seller position information for one or more sellers which is stored in advance in the member DB 104.

Therefore, as illustrated in the drawing, the coupon issuing unit 110 collects the coupons corresponding to selected sellers 1 to 4 from the coupon DB 101 to generate coupon list information and transmits the coupon list information to the buyer terminal 10 to recommend the coupons of adjacent sellers 1 to 4 with reference to the location of the buyer.

In this case, the coupon issuing unit 110 transmits the coupon list information to the buyer terminal 10 as a push message.

Further, the coupon issuing unit 110 extracts discount condition information corresponding to the coupon from the discount condition DB 102 for every coupon included in the coupon list information and compares the discount time zone in accordance with the discount condition information with a time (hereinafter, referred to as a present time) when the location information of the buyer is received to select a coupon having the present time as a discount time zone to generate coupon recommendation information. The coupon issuing unit 110 transmits the coupon recommendation information to the buyer terminal 10 to recommend the coupon.

In this case, the coupon issuing unit 110 transmits the coupon recommendation information like the coupon list information to the buyer terminal 10 as a push message. Further, the coupon issuing unit 110 also transmits the coupon recommendation information as coupon list information.

By doing this, a store of the seller which provides discount by buying a coupon and additional discount in accordance with the discount condition is easily recommended to the buyer at real time so that the buyer uses the coupon in the store of the seller.

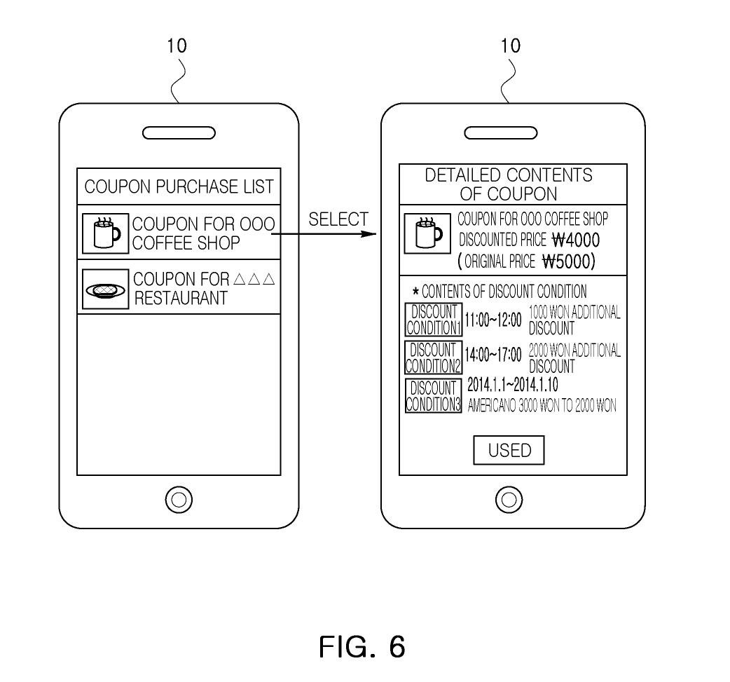

In the meantime, as illustrated in FIG. 6, the buyer terminal 10 matches the coupon information for one or more coupons issued by buying the coupon from the discount service server 100 and the discount condition information to store both information. The application unit 11 included in the buyer terminal 10 may display one or more coupon information on the screen as a list. In this case, the application unit 11 may include a micro controller in which an application is installed to support a coupon related process and information processing in accordance with communication with the discount service server 100.

Further, the application unit 11 may display the coupon information on a coupon selected by the input of the user received through the buyer terminal 10 on a screen of the buyer terminal 10.

For example, as illustrated in the drawing, the application unit 11 provides information on coupon identification information, a discount price, a discount period, and product or service information included in the coupon information corresponding to the selected coupon. Detailed information on one or more discount conditions included in the discount condition information corresponding to the selected coupon may be output through the screen of the buyer terminal 10.

In this case, as illustrated in the drawing, the discount condition information may include one or more different discount conditions.

For example, as the discount condition, a discount price corresponding to the discount time zone may be set and different discount time zones may be set between discount conditions. Further, as the discount condition, a discount price on the product or the service designated by the seller may be set and different products or services may be set between discount conditions. Moreover, as the discount condition, the discount time zone when the designated product or service is used with a discounted price using the coupon may be set.

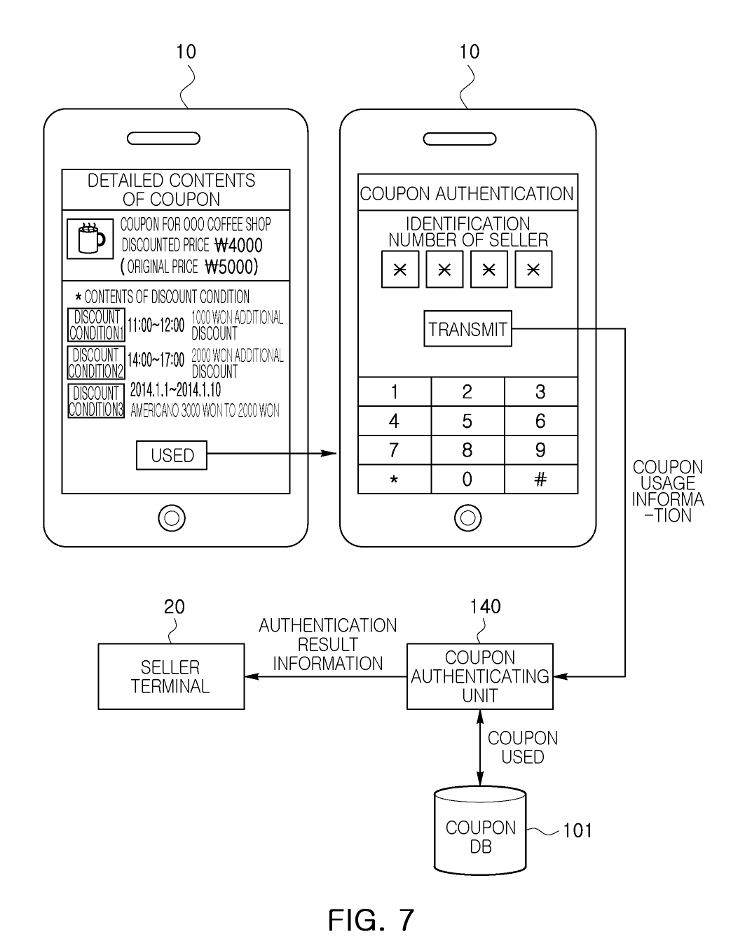

In the meantime, as illustrated in FIG. 7, the application unit 11 of the buyer terminal 10 receives a user input indicating whether to use a coupon in accordance with the coupon information and transmits the coupon usage information to the discount service server 100 through the user terminal 10 when the coupon is used.

To be more specific, when the user input for coupon usage of the buyer who visits a store of the seller corresponding to the coupon to use the coupon is received, the application unit 11 of the buyer terminal 10 outputs an interface for receiving the seller identification information for authenticating a coupon from the seller who faces the buyer through the screen of the buyer terminal 10.

Therefore, the application unit 11 generates seller identification information based on the user input through the interface of the seller who faces the buyer, and generates coupon usage information including the seller identification information in accordance with the generation of the seller identification information to transmit the coupon usage information to the discount server 100 through a communication unit. In this case, the coupon usage information may include coupon information on the used coupon, the buyer identification information, the seller identification information, a coupon used time, and information on the product or the service which is an object to use the coupon.

In this case, when the coupon is used, the application unit 11 transmits the coupon information to the coupon authenticating unit 140 for security of the seller identification information. The coupon authenticating unit 140 extracts the seller identification information corresponding to the coupon information from the coupon DB 101 to the application unit 11. When the seller identification information is a code formed by a plurality of digits, the coupon authenticating unit 140 randomly removes a code for any one digit among the plurality of digits and blocks the remaining code to transmit the code to the application unit 11.

Therefore, the application unit 11 receives only a code corresponding to any one digit which is randomly removed based on the user input of the seller and generates seller identification information together with the blocked code to be included in the coupon usage information and transmit the code to the coupon authenticating unit 140.

In other words, the coupon authenticating unit 140 receives only some information which configures the seller identification information from the buyer terminal 10 for security of the seller identification information and determines whether to match the some information and the seller identification information stored in the coupon DB 101 to perform authentication, which will be described below.

According to the above-described redeem process, when the coupon usage information is received from the buyer terminal 10 through the communication network, the coupon authenticating unit 140 of the discount service server 100 extracts the coupon issuing information for the issued coupon corresponding to the coupon usage information from the coupon DB 101 and compares the seller identification information included in the coupon usage information with the seller identification information included in the coupon issuing information to determine whether the coupon is valid in accordance with the matching, to authenticate the coupon.

Further, when the coupon is valid, the coupon authenticating unit 140 determines whether to use the coupon through the coupon issuing information of a coupon corresponding to the coupon usage information in the coupon DB 101. When the coupon is never used, the coupon authenticating unit 140 processes the coupon issuing information as used one to complete the authentication of the coupon usage and generate authenticating result information and transmit the authenticating result information to the seller terminal 20 or a communication channel which is set in advance by the seller.

Therefore, the seller checks the authenticating result of the coupon of the buyer through the authenticating result information and provides the product or service corresponding to a coupon which is authenticated to be used to the seller.

In the meantime, the discount service server 100 performs the payment procedure on or after the coupon used time in accordance with the above-described configuration and applies the discount condition while performing the payment procedure to change an amount of the payment information to perform the payment procedure.

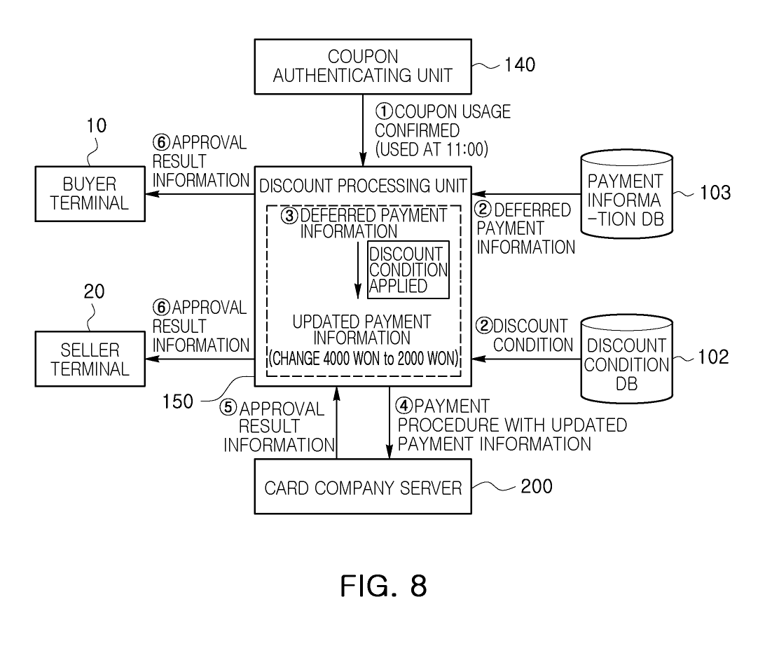

This will be described with reference to FIG. 8. The discount processing unit 150 interlocks with the coupon authenticating unit 140 to extract the deferred payment information corresponding to the used coupon from the payment information DB 103 when the authentication of the coupon usage is completed.

Further, the discount processing unit 150 extracts discount condition information corresponding to the used coupon from the discount condition DB 102 and applies one or more discount conditions included in the discount condition information to the deferred payment information.

To be more specific, the discount processing unit 150 may receive coupon usage information on the coupon which is authenticated to be used from the coupon authenticating unit 140, extract the deferred payment information on the coupon corresponding to the coupon usage information from the payment information DB 103, and extract the discount condition information corresponding to the coupon from the discount condition DB 102. Further, the discount processing unit 150 compares a discount condition on the discount price in accordance with the discount generating condition to which a condition for a discount time zone, or designated product or service is solely or complexly designated with the coupon usage information, applies the discount condition corresponding to the coupon used result according to the coupon usage information (a coupon used store, a coupon used time, and a coupon used object) to the deferred payment information to update the payment information by maintaining the amount of the deterred payment information as it is or changing the amount in accordance with the discount condition, and perform the payment procedure with the updated payment information.

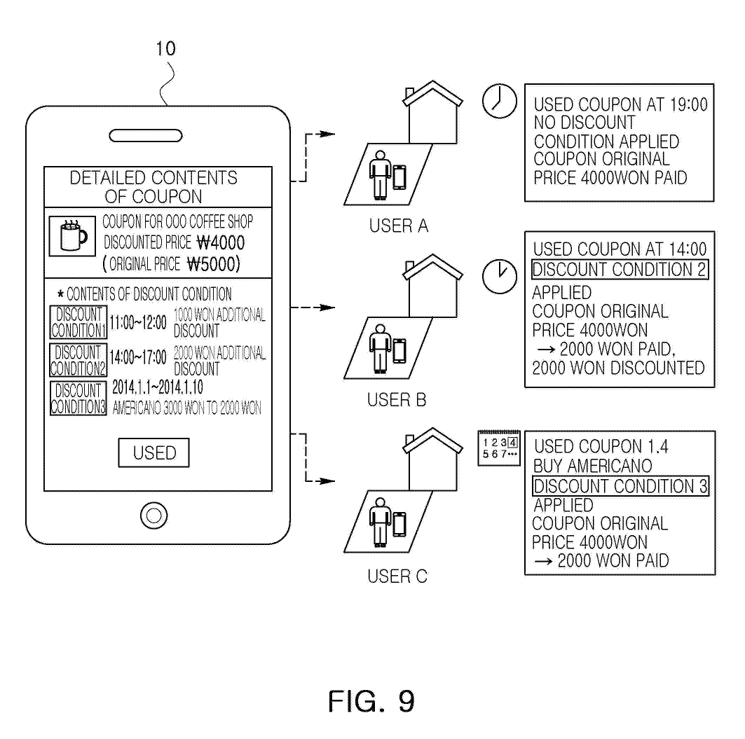

This will be described in more detail through an exemplary embodiment illustrated in FIG. 9. The discount processing unit 150 applies a discount condition in accordance with the discount condition information corresponding to the coupon on users A, B, and C who buy and use the same coupon to perform the payment procedure by maintaining the amount of the deferred payment information as it is or changing the payment procedure.

First, a coupon used time is “17:00” and a user A who does not buy Americano does not satisfy any of discount conditions, so that the discount processing unit 150 does not change the amount of the deterred payment information to perform the payment procedure as it is.

Further, a coupon user time is “14:00” and a user B who does not buy the Americano satisfies the discount condition 2, so that the discount processing unit 150 applies the discount condition 2 to the deferred payment information corresponding to the user B to change 4000 won which is the amount of deferred payment information into 2000 won which is a discount price in accordance with the discount condition 2 to perform the payment procedure.

Furthermore, a coupon user time is January 4 and a user C who bought the Americano satisfies the discount condition 3, so that the discount processing unit 150 applies the discount condition 3 to the deferred payment information corresponding to the user C to change 4000 won which is the amount of deferred payment information into 2000 won which is a discount price in accordance with the discount condition 3 to perform the payment procedure.

In the meantime, the discount processing unit 150 transmits the updated payment information to the card company server 200 to perform the payment procedure. The card company server 200 processes the updated payment information to generate approval result information in accordance with the approval result of the updated payment information to supply the approval result information to the discount processing unit 150.

In this case, the payment information may be statement information in accordance with the card payment. In this case, the payment information managing unit 130 defers buying the statement information and stores the statement information in the payment information DB 103. When the authentication of the coupon usage is completed, the discount processing unit 150 transmits statement buying request information including the statement information to the card company server 200 to perform the payment procedure.

Further, when the approval result is received, the discount processing unit 150 transmits the approval result information into the seller terminal 20 or a predetermined channel to seller member information of the member DB 104 to notify the final amount due to the seller.

Moreover, the discount processing unit 150 transmits the approval result information to the buyer terminal 20 to notify the finally payment amount to the buyer.

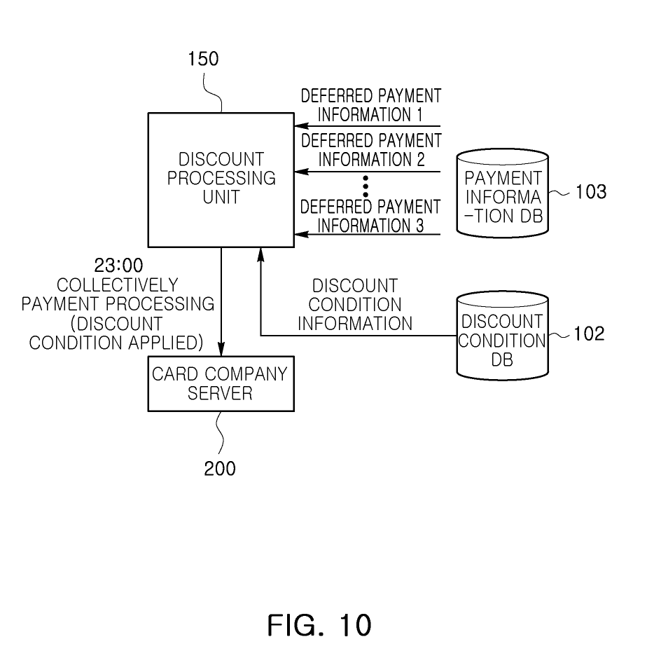

In the meantime, the discount processing unit 150, as illustrated in FIG. 10, does not perform the payment in accordance with the plurality of coupon usage which is completely authenticated through the coupon authenticating unit 140 at the time of authentication, but matches the payment and the deterred payment information stored in the payment information DB 103 to store the payment. Thereafter, at a predetermined time, the discount processing unit 150 collectively performs the payment procedure in accordance with a plurality of deterred payment information corresponding to coupon usage information stored in the payment information DB 103 and the discount condition information stored in the discount condition DB 102.

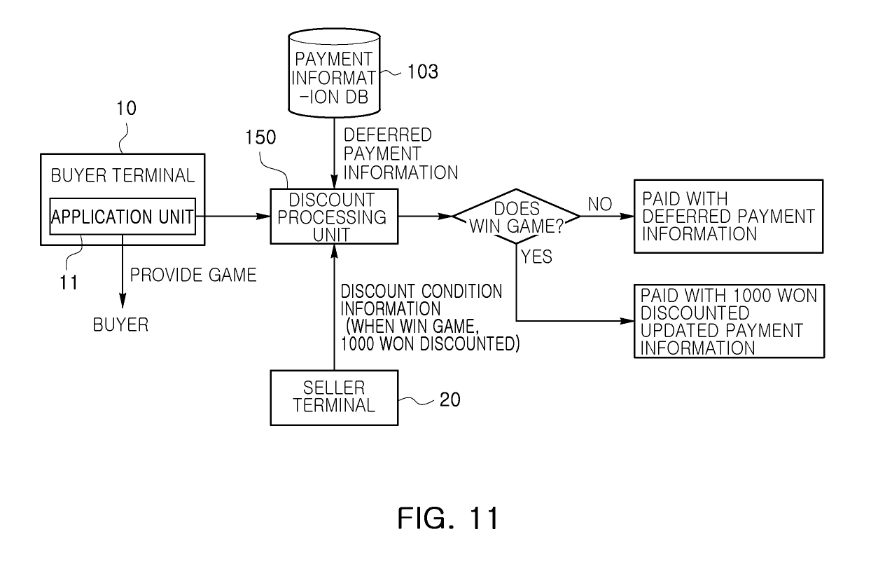

In this case, a time difference between a coupon used time and a payment procedure performed time is caused and a discount condition may also be set using the time difference. An exemplary embodiment thereof will be described in detail with reference to FIG. 11.

As illustrated in FIG. 11, the application unit 11 included in the buyer terminal 10 provides a game and the discount processing unit 150 receives game result information indicating whether to win or lose the game from the application unit 11 through the communication network. In this case, the application unit 11 may be configured to be dedicated for the game and a link may be provided to transmit the game result information to the discount processing unit 150.

Therefore, the seller may set a discount condition that discounts a predetermined amount when the user wins the game. The discount processing unit 150 receives the game result information from the application unit 11 included in the buyer terminal 10 between the coupon used time and a performing time of the payment procedure and when the user winds the game, changes the amount of the deterred payment information into a discounted price in accordance with the discount condition to perform the payment procedure.

As described above, the discount service system corresponding to the discount condition according to the present invention defers the payment procedure of the coupon later to the coupon used time or after using the coupon and sets various discount conditions to apply an additional benefit in accordance with the coupon usage result of the buyer to effectively lead the coupon usage result of the buyer to a seller's desired direction.

That is, the discount service system supports the seller to flexibly vary the profit of the coupon in accordance with the coupon usage result for every buyer. By doing this, the seller may freely designate a time zone which is bad for sales or a discount condition of the designated product or service to maximize the profit of the seller.

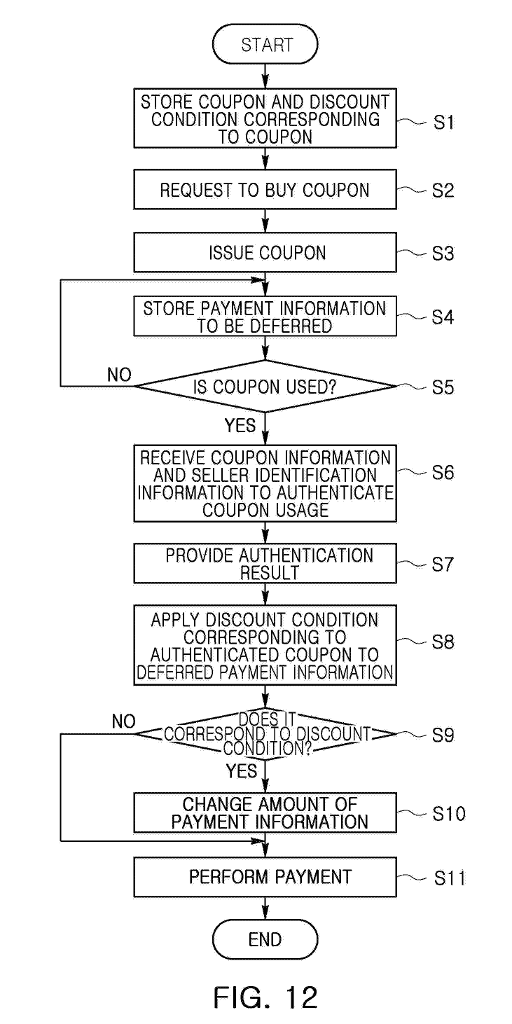

FIG. 12 is a flowchart of a discount service method according to a discount condition as described above. As described above, the discount service server 100 stores coupon information, one or more discount conditions, and user identification information to match each other in step S1.

Next, the discount service server 100 issues a coupon in step S3 in accordance with a coupon purchasing request signal in step S2 of a buyer terminal 10 and stores the payment information in accordance with the coupon purchasing to be deferred in step S4.

Next, the discount service server 100 receives the coupon information when the coupon is used and the coupon usage information including whether to use the coupon including the seller identification information in step S5 from the buyer terminal 10, and compares the coupon issuing information which is stored in advance and the seller identification information to provide the result information to a predetermined channel of the seller to authenticate the usage of the coupon in step S6.

Next, when the seller and the buyer face each other and the coupon usage is authenticated in step S7, the discount service server 100 applies the one or more discount conditions to the payment information of the deferred payment in step S8 and when a discount condition satisfies the coupon usage result among the one or more discount conditions in step S9, maintains the amount included in the deferred payment information as it is or changes the amount in accordance with the discount condition in step S10 to perform the payment in step S11.

Hereinabove, exemplary embodiments of the present invention are illustrated and described. However, the present invention is not limited to the above-described exemplary embodiments and those skilled in the art may modify the present invention in various forms without departing from the gist of the present invention appended in the claims

What is claimed is:

1. A discount service system according to a discount condition, the discount service system comprising:
a discount condition storing unit which receives one or more discount conditions corresponding to a coupon as discount condition information and stores the discount conditions;
a coupon issuing unit which transmits coupon information on the coupon in accordance with a coupon purchasing request to a buyer terminal to issue a coupon;
a payment information managing unit which generates payment information of the buyer in accordance with the coupon purchasing request to store the payment information to be deferred;
a coupon authenticating unit which receives coupon usage information including the coupon information in accordance with the usage of the coupon and seller identification information from the buyer terminal and compares the seller identification information set in advance for the coupon and the coupon usage information to authenticate the usage of the coupon; and
a discount processing unit which when the coupon usage is authenticated by the coupon authenticating unit, maintains an amount of the payment information as it is or changes the amount in accordance with a discount condition included in the discount condition information to perform a payment procedure.

2. The discount service system of claim 1, further comprising:
a location information collecting unit which collects location information of a buyer from the buyer terminal,
wherein the coupon providing unit transmits coupon list information on one or more different coupons including seller position information located within a predetermined radius with respect to the buyer location information based on the buyer location information and seller location information set in advance in the coupon to the buyer terminal.

3. The discount service system of claim 2, wherein the coupon providing unit further includes discount condition information corresponding to each coupon included in the coupon list information in the coupon list information to transmit the coupon list information to the buyer terminal.

4. The discount service system of claim 2, wherein the discount information providing unit transmits the coupon list information to the buyer terminal as a push message.

5. The discount service system of claim 2, wherein the coupon providing unit compares a discount time zone in accordance with each discount condition corresponding to the coupon for every coupon included in the coupon list information and time information corresponding to the location information of the buyer to select a coupon having a discount time zone including the time information as a discount condition to transmit the coupon to the buyer terminal.

6. The discount service system of claim 1, wherein the discount condition information includes one or more discount conditions in which different discount prices are set at every time zone, and the discount processing unit compares the coupon used time in accordance with the coupon usage information and the time zone for every discount condition to change the amount of the payment information in accordance with the predetermined discounted price in the discount condition corresponding to the time zone including the coupon used time.

7. The discount service system of claim 6, wherein when the coupon used time is not included in the time zone of all discount conditions, the discount processing unit performs payment with the deferred payment information.

8. The discount service system of claim 1, wherein the discount processing unit performs the payment on the payment information which is deferred in a predetermined time, and changes the amount of the payment information in accordance with the satisfied discount condition to perform the payment when any one of discount conditions included in the discount condition information is satisfied between the payment proceeding time in accordance with the proceeding of the payment and the coupon used time in accordance with the coupon usage information.

9. The discount service system of claim 1, wherein the payment information is statement information in accordance with the card usage of the buyer.

10. The discount service system of claim 1, wherein the discount processing unit transmits approval result information of approval result to the seller terminal when the payment information in accordance with the payment proceeding is approved.

11. A discount service method according to discount conditions, the method comprising:
matching coupon information, discount conditions, and seller identification information to store, by a discount service server which communicates with a buyer terminal;
issuing a coupon in accordance with a coupon purchasing request signal of the buyer terminal, by the discount service server and storing the payment information in accordance with the coupon purchase to be deferred;
receiving coupon usage information including the coupon information and the seller identification information through the buyer terminal, by the discount service server, and comparing the previously stored coupon issuing information and seller identification information to provide the result information to a predetermined channel of the seller; and
maintaining the amount included in the deferred payment information as it is or changing the amount to perform the payment in accordance with the discount condition when the discount service server authenticates the coupon usage in a face to face status.
